(19) United States
(12) Patent Application Publication
(10) Pub. No.: US 2024/0002564 A1
(43) Pub. Date: Jan. 4, 2024

(54) COPOLYMERS OF DIISOALKENYLARENE AND COMPOSITIONS THEREOF

(71) Applicant: Kraton Corporation, Houston, TX (US)

(72) Inventors: Jason Tian, Houston, TX (US); Ruidong Ding, Houston, TX (US); Vijay Mhetar, Houston, TX (US)

(73) Assignee: Kraton Corporation, Houston, TX (US)

(21) Appl. No.: 18/468,814

(22) Filed: Sep. 18, 2023

Related U.S. Application Data
(63) Continuation-in-part of application No. 17/644,146, filed on Dec. 14, 2021.
Application No. 17/644,146 is a continuation-in-part of application No. 18/344,988, filed on Jun. 30, 2023.
(60) Provisional application No. 63/375,895, filed on Sep. 16, 2022.
(60) Provisional application No. 63/130,130, filed on Dec. 23, 2020.
(60) Provisional application No. 63/367,531, filed on Jul. 1, 2022.

(51) Int. Cl. C08F 212/36; C08J 5/24; B32B 15/082; B32B 15/20

(52) U.S. Cl. CPC C08F 212/36; C08J 5/246; B32B 15/082; B32B 2457/08; B32B 2311/12; B32B 2307/308; B32B 15/20

(57) ABSTRACT

The disclosure relates to a thermosetting composition comprising a copolymer of (a) a diisoalkenylarene (DIAEA), and (b) a divinylarene (DVA) comprising m-DVB, p-DVB, m-EVB, p-EVB, and mixtures thereof. A mole ratio of DIAEA to DVA is from 15:1 to 1:15. The thermosetting composition after curing at a temperature of ≥120° C. is characterized as having: a Gel Content of >90%, a Dk of <2.6 and Df of <0.002, both measured at 10 GHz, according to ASTM D2520. The thermosetting composition provides improved thermal stability at high temperature and excellent processability when used electronic applications as metal-clad laminates and build-up films.

### RELATED APPLICATIONS

This application claims benefit to U.S. provisional application No. 63/375,895, filed on Sep. 16, 2022, which is hereby incorporated herein by reference. This application is a continuation-in-part of U.S. patent application Ser. No. 17/644,146 with a filing date of Dec. 14, 2021, and U.S. patent application Ser. No. 18/344,988 with a filing date of Jun. 30, 2023, which are incorporated herein by reference.

### FIELD

The disclosure relates to copolymers of diisoalkenylarene, compositions and applications thereof.

### BACKGROUND

High heat-resistant materials are essential for the fabrication of electronic components, including dielectric layers, copper clad laminates (CCLs), and printed circuit boards (PCBs) used in miniaturized electronic devices. Materials for making these components need to possess desirable properties such as low dielectric constants (Dk), minimal dissipation factors (Df), low coefficients of thermal expansion (CTE), strong adhesion to diverse substrates, low water absorption, etc.

Cross-linkable (co)polymer compositions offer the advantage of high heat resistance alongside other sought-after properties such as low Dk and Df. These (co)polymers can be designed with reactive functional groups like vinyl, epoxy, etc., facilitating increased cross-linking density upon curing, either with or without cross-linking agents. Enhancements to the properties of these (co)polymers can be achieved through the creation of composites, where (co)polymers are combined with reinforcing materials such as fibers or fillers, catering to specific applications, including electronics.

There remains a requirement for a thermosetting composition that incorporates cross-linkable (co)polymers, aiming to achieve the thermosetting composition characterized by robust stability, exceptional workability, and enhanced electrical and mechanical properties.

### SUMMARY

In one aspect, the disclosure relates to a thermosetting composition comprising, consisting essentially of, or consists of a copolymer of (a) a diisoalkenylarene (DIAEA) and (b) a divinylarene (DVA) comprising m-divinylbenzene (m-DVB), p-divinylbenzene (p-DVB), m-ethylvinylbenzene (m-EVB), p-ethylvinylbenzene (p-DVB), and mixtures thereof. A mole ratio of DIAEA to DVA is from 15:1 to 1:15. The thermosetting composition after curing at a temperature of greater than 120° C. is characterized as having: a Gel Content of >90%, measured according to Gel Content Test as described in the specification; and a dielectric constant (Dk) of <2.8 and a dissipation Factor (Df) of <0.002, both measured at 10 GHz, according to ASTM D2520.

In a second aspect, DVA has a combination of m-DVB and p-DVB in an amount of up to 99 wt. %, based on total weight of the DVA.

In a third aspect, DVA comprises m-DVB in an amount of >50 wt. %, based on total weight of DVA.

In a fourth aspect, DVA comprises a combination of m-EVB and p-EVB in an amount of <35 wt. %, based on total weight of DVA.

### DESCRIPTION

The following terms will be used throughout the specification:

“At least one of [a group such as X, Y, and Z]” or “any of [a group such as X, Y, and Z]” means a single member from the group, more than one member from the group, or a combination of members from the group. For example, at least one of X, Y, and Z includes, for example, X only, Y only, or Z only, as well as X and Y, X and Z, Y and Z; or X, Y, and Z, or any other all combinations of X, Y, and Z.

A list of embodiments presented as “X, Y, or Z” is to be interpreted as including the embodiments, X only, Y only, Z only, “X or Y,” “X or Z,” “Y or Z,” or “X, Y, or Z”.

“Cured” or “cross-linked” used interchangeably and refers to the formation of covalent bonds that link one polymer chain to another or link one polymerized repeating unit to another in the same polymer chain thereby altering the properties of the material.

“Molecular weight” or M_{w} refers to the polystyrene equivalent molecular weight in g/mol of a polymer block or a block copolymer. M_{w} can be measured with gel permeation chromatography (GPC) using polystyrene calibration standards, such as is done according to ASTM 5296. The GPC detector can be an ultraviolet or refractive index detector or a combination thereof. The chromatograph is calibrated using commercially available polystyrene molecular weight standards. M_{w} of polymers measured using GPC so calibrated are polystyrene equivalent molecular weights or apparent molecular weights. M_{w} expressed herein is measured at the peak of the GPC trace and are commonly referred to as polystyrene equivalent “peak molecular weight,” designated as Mₚ.

“Substantially Gel-Free” refers to a polymer containing <10, or <8, or <5, or <3, or <2, or <1 wt. % of a solid matter insoluble in a hydrocarbon solvent, e.g., toluene, cyclohexane, methyl-ethyl ketone (MEK), xylene, etc., or a mixture of hydrocarbon solvents.

“Gel Content” refers to the insoluble contents of a cured polymer composition in toluene as a percentage of the cured polymer composition (prior to immersing in a hydrocarbon solvent). In embodiments, the Gel Content is >90 wt. % (toluene extractable of <10 wt. %), or >95 wt. % (toluene extractable of <5 wt. %), or >98 wt. % (toluene extractable of <2 wt. %).

“Gel Content Test” refers to a measurement of a Gel Content by placing a sample of a cured polymer composition having a weight G1 in 20 times volume of toluene, for a period of 4 hours at room temperature. Content in toluene is then filtered to recover the solid portion of the cured polymer composition, then dried to fully remove the solvent, and weighed, giving the insoluble content G2. Gel Content is calculated as (G2/G1). In embodiments, the Gel Content can also be measured by soaking the sample of the cured polymer composition at 90° C. for 9 hours followed by filtration of solid portion, drying, and recording weight.

“Solubility Test” refers to a measurement of a solubility by placing a polymer/copolymer sample in about 10 times volume of a hydrocarbon solvent, e.g., toluene, shake well and leave up to 4 hours at room temperature. Afterwards, examine the polymer/copolymer in the solvent by visual observation whether it has dissolved completely or partially. Decant or filter the content to measure weight of the remaining polymer/copolymer, after drying, to calculate weight of the dissolved polymer/copolymer.

“Swelling Content” refers to a weight difference (W %) of a weight of a cured polymer composition after being immersed in toluene until fully saturated (W2), i.e., the sample weight remains the same after a period of time, not soaking any more toluene, and the weight of the curable polymer composition before immersion (W1), calculated as:

W %=(W2−W1)/W1*100

Df indicates “Dissipation Factor” or “loss tangent” (Df) and is a measure of loss rate of electrical energy in a dissipative system.

Dk indicates dielectric constant or permittivity.

The disclosure relates to a thermosetting composition containing a copolymer of: (a) a diisoalkenylarene (DIAEA) and (b) a divinylarene (DVA) comprising m-DVB, p-DVB, m-EVB, p-EVB, and mixtures thereof. The thermosetting composition containing the DIAEA-DVA copolymer provides improved thermal stability at high temperature, excellent processability, and electrical properties, e.g., Dk and Df. The thermosetting composition can be used in metal-clad laminates for electronic applications.

(DIAEA-DVA Copolymers)

The DIAEA-DVA copolymer can be obtained from DIAEA, DVA, and optionally other polymerizable monomers by cationic polymerization in the presence of a Lewis acid or a Bronsted acid catalyst. In embodiments, the copolymer comprises: polymerized DIAEA in amounts of 30-95, or 35-90, or 40-80, or 20-60, or 30-70 wt. %; polymerized DVA in amounts of 5-70, or 10-65, or 20-60, or 40-80, or 30-70 wt. %; and other polymerized monomers in amounts of 0-15, or 1-12, or 2-10, or 5-15 wt. %, based on total weight of the copolymer.

In embodiments, the DIAEA-DVA copolymer has a mole ratio of DIAEA to DVA of 15:1 to 1:15, or 12:1 to 1:12, or 10:1 to 1:10, or 8:1 to 1:8, or 5:1 to 1:5, or 4:1 to 1:4, or 3:1 to 1:3, or 2:1 to 1:2, or 1:1.

(DIAEA Monomers)

In embodiments, the copolymerized DIAEA monomer comprises at least one of repeat units (A), (B), (C), and (D) whose structures are shown below, where R¹ is H or a C₁-C₈ alkyl group. The DIAEA-DVA copolymer can have any order of the repeat units of copolymerized DIAEA and DVA monomers.

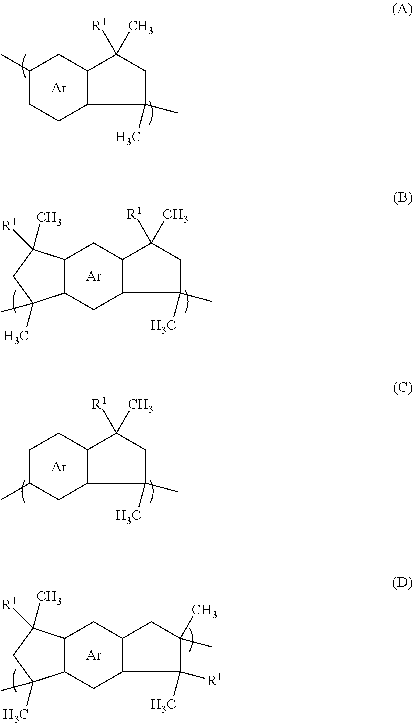

Non-limiting examples of DIAEA monomers to produce the copolymer include compounds having structures (I) 1,3-diisoalkenylarene, (II) 1,4-diisoalkenylarene, or mixtures thereof, wherein R¹ is methyl, ethyl, isopropyl, or n-butyl.

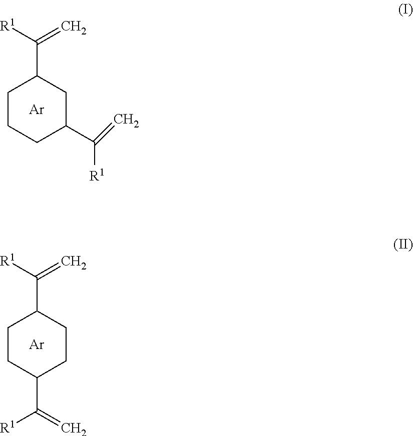

In embodiments, DIAEA is selected from diisopropenylbenzenes (DIPEBs) and their substituted variants for producing the copolymer. Examples of DIPEB s include but are not limited to: 1,3-diisopropenylbenzene; 1,2-diisopropenylbenzene; 1,4-diisopropenylbenzene; 3,4-dicyclohexyl-1,2-diisopropenyl-benzene; 5-(3-methyl-cyclopentyl)-1,3-diisopropenylbenzene; 3-cyclopentyl-methyl-6-n-propyl-1,4-diisopropenylbenzene; 4-(2-cyclo-butyl-1-ethyl)-1,2-diisopropenylbenzene; 3-(2-n-propylcyclopropyl)-1,4-diisopropenylbenzene; 2-methyl-5-n-hexyl-1,3-diisopropenylbenzene; 4-methyl-1,2-diisopropenyl-benzene; 5-ethyl-1,3-diisopropenylbenzene; 3-methyl-1,4-diisopropenylbenzene; and mixtures thereof.

In embodiments, DIAEA is DIPEB comprising o-DIPEB, m-DIPEB, and p-DIPEB. In embodiments, DIPEB contains >75, or >80, or >85, or >90, or >95, or >98, or up to 100 wt. % of m-DIPEB, based on total weight of DIPEB.

In embodiments, DIAEA is DIPEB having a moisture content of <150 ppm, or <120 ppm, or <100 ppm, or <80 ppm, based on total weight of DIPEB.

In embodiments, DIAEA is DIPEB having a 4-tert-buylcatechol (p-TBC) content of <120 ppm, or <100 ppm, or <90 ppm, or <80 ppm, based on total weight of DIPEB.

In embodiments, DIAEA is DIPEB, having a Hazen (APHA) color of <50, or <45, or <40, or <35, or <30, or <20 in a solvent having a concentration of 10%, measured according to ASTM D1209.

(DVA Monomers)

DVA is selected from the group consisting of divinylbenzene (DVB), ethylvinylbenzene (EVB), 1,3-divinylnaphthalene, 1,8-divinylnaphthalene, 1,4-divinylnaphthalene, 1,5-divinylnaphthalene, 2,3-divinylnaphthalene, 2,7-divinylnaphthalene, 2,6-divinylnaphthalene, 4,4′-divinylbiphenyl, 4,3′-divinylbiphenyl, 4,2′-divinylbiphenyl, 3,2′-divinylbiphenyl, 3,3′-divinylbiphenyl, 2,2′-divinylbiphenyl, 2,4-divinylbiphenyl, 1,2-divinyl-3,4-dimethylbenzene, 1,3-divinyl-4,5,8-tributylnaphthalene, 2,2′-divinyl 4-ethyl-4′-propylbiphenyl, and mixtures thereof.

Examples of DVB include o-DVB (1,2-divinylbenzene), p-DVB (1,3-divinylbenzene), m-DVB (1,4-divinylbenzene), trivinylbenzene, or mixtures thereof. In embodiments, DVB comprises two or more compounds selected from o-DVB, m-DVB, p-DVB, vinyl benzene, diethylbenzene, EVB, and mixtures thereof.

In embodiments, DVA is DVB, which comprises m-DVB, p-DVB, m-EVB, p-EVB, and mixtures thereof.

In embodiments, DVA is DVB, which contains 50-99, or 55-95, or 50-85, or 50-80, or >50, or >90, or >97 wt. % of m-DVB, based on total weight of DVB.

In embodiments, DVA is DVB having a weight ratio of m-DVB to p-DVB from 5:1-1:5, or 4:1-1:4, or 3:1-1:3, or 2:1-1:2.

In embodiments, DVA is DVB, which contains 35-45 wt. % m-DVB, 35-45 wt. % p-DVB, 5-15 wt. % m-EVB, and 5-20 wt. % p-EVB, based on total weight of DVB.

In embodiments, DVA has sum of m-DVB, p-DVB, m-EVB, and p-EVB of >80, or >85, or >90, or >92, or >95 wt. %, based on total weight of DVA.

In embodiments, DVA is DVB having a combination of m-DVB and p-DVB in amounts of 50-99, or 55-85, or 50-80, or 55-80, >50, or >85, or up to 99 wt. %, based on total weight of DVB.

In embodiments, DVA is DVB having a combination of m-EVB and p-EVB in amounts of <35, or <30, or <20, or <10, or <5, or 1-25, or <1, or <0.5, or <0.1 wt. %, based on total weight of DVB.

In embodiments, DVA is DVB having a purity of >90%, or >80%, or >70%, or >60%, or >50%, based on total weight of DVB. The “purity” of DVB is defined as the presence of single isomer of greater than certain percentage in the mixture of all isomers, e.g., o-DVB, m-DVB, or p-DVB.

In embodiments, DVA is DVB having a 4-tert-buylcatechol (p-TBC) content of <1200 ppm, or <1100 ppm, or <1000 ppm, or <800 ppm, based on total weight of DVB.

In embodiments, DVA is DVB having a moisture content of <130 ppm, or <120 ppm, or <100 ppm, or <80 ppm, based on total weight of DVB.

In embodiments, DVA is DVB having a naphthalene content of <1000, or <800, or <700, or <500 ppm, based on total weight of DVB.

Examples of commercially available DVB monomer include DVB 80, DVB 55, DVB 63 from Deltech Corp.; DVB 55, DVB 63, and DVB HP from DuPont.

(DVA Purification/Separation)

In embodiments, DVA monomers, such as DVB, are purified and/or fractionated to select isomers via a Simulated Moving Bed (SMB) or via moving bed chromatography method.

(Optionally Other Polymerizable Monomers)

In embodiments, the DIAEA-DVA copolymer comprises other polymerizable monomers selected from the group consisting of styrene, 2-vinylbiphenyl, 3-vinylbiphenyl, 4-vinylbiphenyl, 1-vinylnaphthalene, 2-vinylnaphthalene, α-alkylated styrene, alkoxylated styrene, and mixtures thereof.

Non-limiting examples of α-alkylated styrene include α-methylstyrene, α-ethylstyrene, α-propylstyrene, α-n-butylstyrene, α-isobutylstyrene, α-t-butylstyrene, α-n-pentylstyrene, α-2-methylbutylstyrene, α-3-methylbutyl-2-styrene, α-t-pentylstyrene, α-n-hexylstyrene, α-2-methylpentylstyrene, α-3-methylpentylstyrene, α-1-methylpentylstyrene, α-2,2-dimethylbutylstyrene, α-2,3-dimethylbutylstyrene, α-2,4-dimethylbutylstyrene, α-3,3-dimethylbutylstyrene, α-3,4-dimethylbutylstyrene, α-4,4-dimethylbutylstyrene, α-2-ethylbutylstyrene, α-1-ethylbutylstyrene, α-cyclohexylstyrene, and mixtures thereof. In embodiments, other alkylated styrene compounds include m-methylstyrene, p-methylstyrene, m-propylstyrene, p-propylstyrene, m-n-butylstyrene, p-n-butylstyrene, m-t-butylstyrene, p-t-butylstyrene, m-n-hexylstyrene, p-n-hexylstyrene, m-cyclohexylstyrene, p-cyclohexylstyrene, and mixtures thereof. Examples of the alkoxylated styrene include o-ethoxystyrene, m-ethoxystyrene, p-ethoxystyrene, o-propoxystyrene, m-propoxystyrene, p-propoxystyrene, o-n-butoxystyrene, m-n-butoxystyrene, p-n-butoxystyrene, o-isobutoxystyrene, m-isobutoxystyrene, p-isobutoxystyrene, o-t-butoxystyrene, m-t-butoxystyrene, p-t-butoxystyrene, o-n-pentoxystyrene, m-n-pentoxystyrene, p-n-pentoxystyrene, α-methyl-o-butoxystyrene, α-methyl-mbutoxystyrene, α-methyl-p-butoxystyrene, o-t-pentoxystyrene, m-t-pentoxystyrene, p-t-pentoxystyrene, o-n-hexoxystyrene, m-n-hexoxystyrene, p-n-hexoxystyrene, α-methyl-o-pentoxystyrene, α-methyl-m-pentoxystyrene, α-methyl-p-pentoxystyrene, o-cyclohexoxystyrene, m-cyclohexoxystyrene, p-cyclohexoxystyrene, o-phenoxystyrene, m-phenoxystyrene, p-phenoxystyrene, and mixtures thereof.

In embodiments, other polymerizable monomers include mono, di, or multi-functional compounds selected from butadiene, isoprene, piperylene, divinyltoluene, divinylpyridine, divinylxylene, vinyltriisopropenoxysilane, methoxytrivinylsilane, tetravinylsilane, diethoxydivinylsilane, o-ethylvinylbenzene, m-ethylvinylbenzene, p-ethylvinylbenzene, 2-vinyl-T-ethylbiphenyl, 2-vinyl-3′-ethylbiphenyl, 2-vinyl-4′-ethylbiphenyl, 3-vinyl-2′-ethylbiphenyl, 3-vinyl-3′-ethylbiphenyl, 3-vinyl-4′-ethylbiphenyl, 4-vinyl-2′-ethylbiphenyl, 4-vinyl-3′-ethylbiphenyl, 4-vinyl-4′-ethylbiphenyl, 1-vinyl-2-ethylnaphthalene, 1-vinyl-3-ethylnaphthalene, l-vinyl-4-ethylnaphthalene, 1-vinyl-5-ethylnaphthalene, l-vinyl-6-ethylnaphthalene, l-vinyl-7-ethylnaphthalene, 1-vinyl-8-ethylnaphthalene, 2-vinyl-1-ethylnaphthalene, 2-vinyl-3-ethylnaphthalene, 2-vinyl-4-ethylnaphthalene, 2-vinyl-5-ethylnaphthalene, 2-vinyl-6-ethylnaphthalene, 2-vinyl-7-ethylnaphthalene, 2-vinyl-8-ethylnaphthalene, 2-vinyl-T-propylbiphenyl, 2-vinyl-3′-propylbiphenyl, 2-vinyl-4′-propylbiphenyl, 3-vinyl-T-propylbiphenyl, 3-vinyl-3′-propylbiphenyl, 3-vinyl-4′-propylbiphenyl, 4-vinyl-T-propylbiphenyl, 4-vinyl-3′-propylbiphenyl, 4-vinyl-4′-propylbiphenyl, 1-vinyl-2-propylnaphthalene, 1-vinyl-3-propylnaphthalene, 1-vinyl-4-propylnaphthalene, 1-vinyl-5-propylnaphthalene, 1-vinyl-6-propylnaphthalene, 1-vinyl-7-propylnaphthalene, 1-vinyl-8-propylnaphthalene, 2-vinyl-1-propylnaphthalene, 2-vinyl-3-propylnaphthalene, 2-vinyl-4-propylnaphthalene, 2-vinyl-5-propylnaphthalene, 2-vinyl-6-propylnaphthalene, 2-vinyl-7-propylnaphthalene, 2-vinyl-8-propylnaphthalene, 1,2,4-trivinylbenzene, 1,3,5-trivinylbenzene, 1,2,4-triisopropenylbenzene, 1,3,5-triisopropenylbenzene, 1,3,5-trivinylnaphthalene, 3,5,4′-trivinylbiphenyl, indene, alkylated indene, such as methylindene, ethylindene, propylindene, butylindene, t-butylindene, sec-butylindene, n-pentylindene, 2-methyl-butylindene, 3-methyl-butylindene, n-hexylindene, 2-methyl-pentylindene, 3-methyl-pentylindene, 4-methyl-pentylindene, alkycoxyindene such as methoxy indene, ethoxy indene, propoxy indene, butoxy indene, t-butoxy indene, sec-butoxy indene, n-pentoxyindene, 2-methyl-butoxyindene, 3-methyl-butoxyindene, n-hexitosiindene, 2-methyl-pentoxyindene, 3-methyl-pentoxyindene, 4-methyl-pentoxyindene, acenaphthylenes such as alkylacenaphthylenes, halogenated acenaphthylenes, phenylacenaphthylenes, and mixtures thereof. Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, 5-ethyl acenaphthylene, and mixtures thereof. Examples of the halogenated acenaphthylenes include 1-chloroacenaphthylene, 3-chloroacenaphthylene, 4-chloroacenaphthylene, 5-chloroacenaphthylene, 1-bromoacenaphthylene, 3-bromoacenaphthylene, 4-bromoacenaphthylene, and 5-bromoacenaphthylene, and mixtures thereof. Examples of the phenylacenaphthylenes include 1-phenylacenaphthylene, 3-phenylacenaphthylene, 4-phenylacenaphthylene, 5-phenylacenaphthylene, and mixtures thereof.

In embodiments, the DIAEA-DVA copolymer further comprises repeat units derived from monomers including: (i) a cyclodiene or a dimer thereof; (ii) an adduct of a cyclodiene and an acyclic diene; (iii) an allyl compound having two or more allyl groups; and any combination or sub-combination thereof. Examples of cyclic polymerizable monomers include 1,3-cyclohexadiene, 1,4-cyclohexadiene, 1,3-cyclopentadiene, alkyl cyclopentadiene, trivinylcyclohexane, 2,4,6,8-tetravinyl-2,4,6,8-tetramethylcyclotetrasiloxane, 2,4,6,8,10-pentamethyl-2,4,6,8,10-pentavinylcyclopentasiloxane, or mixtures thereof.

In embodiments, the DIAEA-DVA copolymer comprises low molecular weight species in amounts of 0.25-25, or 0.50-20, or 1-15, or 0.25-10, or 0.5-20 wt. %, based on total weight of the copolymer. Low molecular weight species defined as having a molecular weight of <0.5 kg/mol.

(DIAEA-DVA Copolymer Structures)

In embodiments, the DIAEA-DVA copolymer is any of a random, or block copolymer. Alternatively, the copolymer can contain a homopolymer of DIAEA monomer end capped with DVA comonomer to obtain a DVA end capped polyDIAEA.

The DIAEA-DVA copolymer can have at least one terminal group selected from (E), (F), (G), and (H), having structures shown below.

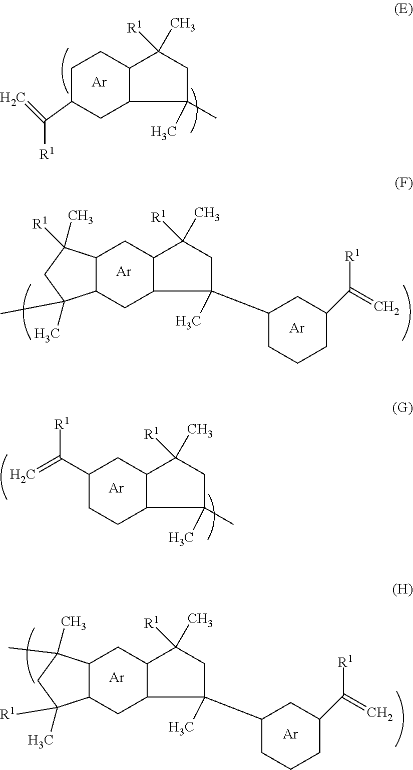

The copolymer can be functionalized with functional groups, such as isocyanate, anhydride, carboxylic acid, carboxylic ester, hydroxyl, vinyl, urethane, amino, phosphino, silane, acrylate, methacrylate, or epoxy groups using methods known in the art.

In embodiments, the DIAEA-DVA copolymer is a DIPEB-DVB copolymer.

Depending on the application (e.g., films, prepreg, etc.), in embodiments, the DIAEA-DVA copolymer is present in an amount of 25-99.90, or 30-85, or 35-80, or 40-75, or 45-70, or >25, or <90 wt. %, based on total weight of the thermosetting composition.

(Methods of Preparation of DIAEA-DVA Copolymers)

The copolymer can be prepared by processes known in the art and disclosed and taught in U.S. Patent Application Publication 2022/0195109 A1, incorporated herein by reference. In embodiments, the copolymer is prepared by polymerizing DIAEA, DVA, and optionally other polymerizable monomers under cationic conditions in a suitable solvent in the presence of a catalyst, e.g., a Bronsted acid, or a Lewis acid. The addition of monomers can be carried at a suitable temperature and the polymerization continued until all the monomers have essentially disappeared, or alternately, until an analysis of the reaction mixture indicates that the copolymer of sufficient molecular weight has formed. At the end of the reaction, the copolymer can be isolated by quenching the reaction mixture with water, followed by separating the organic solvent layer and stripping the solvent. Trace organics can be removed from the product under high vacuum. In embodiments, the catalyst is used in amounts of 0.01-5, or 0.1-3, or 0.5-2, or 0.01-2 wt. %, based on total weight of monomers to be polymerized.

In embodiments, the DIAEA-DVA copolymer is obtained by photopolymerization of DIAEA, DVA, and optionally other polymerizable monomers in the presence of a photo initiator commonly known in the art. In embodiments, photopolymerization is by using a radiation source, e.g., UV radiation, gamma radiation, electron-beam (E-beam), or microwave, for 10 sec.-60 min., or 20 sec.-30 min., or 30 sec.-10 min., or 10 sec.-60 sec.

(Additives)

In embodiments, the thermosetting composition comprises at least an additive selected from initiators, activators, stabilizers, neutralizing agents, thickeners, coalescing agents, slip agents, release agents, antioxidants, antiozonants, color change pH indicators, plasticizers, tackifiers, film forming additives, dyes, pigments, UV stabilizers, fillers, flame retardants, viscosity modifiers, wetting agents, deaerators, toughening agents, adhesion promoters, heat stabilizers, lubricants, flow modifiers, drip retardants, antistatic agents, processing aids, stress-relief additives, accelerator, water resistant agents, water-proofing agents, thermal conductivity-imparting agents, electromagnetic wave shielding property-imparting agents, radical scavengers, and mixtures thereof.

Additives, if added, can be in amounts up to 30, or 0.1-30, or 0.1-20, or 1-10, or 0.5-5, or 0.1-5 wt. %, based on total weight of the thermosetting composition.

(Optional Polymers/Rubbers)

In embodiments, the thermosetting composition comprises polymers other than the DIAEA-DVA copolymer. The polymer can be selected from 1,2-polybutadiene, polyisoprene, polybutadiene-polyisoprene copolymers, polybutadiene-polystyrene-polydivinyl-benzene terpolymers, polyphenylene ether, curable cyclic olefins or their copolymers, polyacrylates, polydicyclopentadiene, styrene-isoprene-styrene copolymers, butadiene-acrylonitrile copolymers, acrylonitrile-styrene resin, acrylonitrile-butadiene-styrene resin, polyesters, styrenic block copolymers (SBCs), polyolefins, polytetrafluoroethylene (PTFE), polyetherimide (PEI), maleimide resin, cyanate ester resin, epoxy resin, phenolic resin, benzoxazine resin, polyamide resin, polyimide resin, polyphenylene sulfide, polyacetal, polysulfone, polyesterimides, polyether sulfone, polyether ketone, fluorine resin, polycarbonates, polyarylates, polyethers, polyamidoimides, polyurethanes, polyether ethersulfones, polybutadienediols, polyisoprenediol, polyisobutylenediol, hydrogenated polybutadienediol, polyethylenediol, polypropylenediol, polycaprolactonediol, polyethylene adipate, polybutylene adipate, polyethylene terephthalate, polybutylene terephthalate, silanol-terminal polydimethylsiloxane, amino-terminal polyethylene glycol, amino-terminal polypropylene glycol, amino-terminal polybutadiene, poly(3-hydroxybutyrate), poly(4-hydroxybutyrate), poly(3-hydroxybutyrate-co-3-hydroxyvalerate), poly(ε-caprolactone), and mixtures thereof.

In embodiments, an epoxy resin comprises glycidyl groups, alicyclic epoxy groups, oxirane groups, ethoxyline groups, and the like. Specific examples of the epoxy resins include novolac-type epoxy resin, cresol-novolac epoxy resin, triphenolalkane-type epoxy resin, aralkyl-type epoxy resin, aralkyl-type epoxy resin having a biphenyl skeleton, biphenyl-type epoxy resin, dicyclopentadiene-type epoxy resin, heterocyclic-type epoxy resin, epoxy resin containing a naphthalene ring, a bisphenol-A type epoxy compound, a bisphenol-F type epoxy compound, stilbene-type epoxy resin, trimethylol-propane type epoxy resin, terpene-modified epoxy resin, linear aliphatic epoxy resin obtained by oxidizing olefin bonds with peracetic acid or a similar peracid, alicyclic epoxy resin, sulfur-containing epoxy resin, N,N, N′,N′-tetraglycidyl-m-xylenediamine, N,N,N′,N′-tetraglycidylmethylenedianiline, anthracene based epoxy resin, pyrene based epoxy resin, naphthalene based epoxy resin, and mixtures thereof. In embodiments, naphthalene based epoxy resins include di-naphthalene based epoxy resin, tetra-naphthalene based epoxy resin, oxazolidone-containing di-naphthalene based epoxy resin, and the like.

In embodiments, a cyanate ester resin comprises at least one unit of —O—CN. Cyanate esters can contain units of Ar—O—CN, wherein Ar is substituted or unsubstituted benzene, biphenyl, naphthalene, phenol novolac, bisphenol A, bisphenol A novolac, bisphenol F, bisphenol F novolac, or phenolphthalein. The Ar can be bonded with substituted or unsubstituted dicyclopentadienyl. The cyanate ester resin can be obtained from compounds selected from but not limited to polyfunctional aliphatic isocyanate compounds, polyfunctional alicyclic isocyanate compounds, polyfunctional aromatic isocyanate compounds such as trimethylene diisocyanate, tetramethylene diisocyanate, methylene diisocyanate, pentamethylene diisocyanate, 1,2-propylene diisocyanate, 1,3-butylene diisocyanate, dodecamethylene diisocyanate, 2,4,4-trimethyl hexamethylene diisocyanate and the like, 1,3-cyclopentene diisocyanate, 1,3-cyclohexane diisocyanate, 1,4-cyclohexane diisocyanate, isophorone diisocyanate, hydrogenated diphenylmethane diisocyanates, hydrogenated xylylene diisocyanate, hydrogenated tolylene diisocyanate, hydrogenated tetramethylxylylene diisocyanate, phenylene diisocyanate, 2,4-tolylene diisocyanate, 2,6-tolylene diisocyanate, 2,2′-diphenylmethane diisocyanate, 4,4′-diphenylmethane diisocyanate, 4,4′-toluidine diisocyanate, 4,4′-diphenyl ether diisocyanate, 4,4′-diphenyldiisocyanate, 1,5-naphthalene diisocyanate, benzene methylene diisocyanate, 2,4′-diphenyl methane diisocyanate, 4,4′-diphenyl methane diisocyanate, carbodiimide modified product of 4,4′-diphenyl methane diisocyanate, polymethylene polyphenyl polyisocyanate, tolidine diisocyanate, xylene diisocyanate, tetramethyl xylene diisocyanate, hydrogenated diphenyl methane diisocyanate, hydrogenated xylene diisocyanate, norbonane diisocyanate, biuret modified hexamethylene diisocyanate, dimeric acid diisocyanate, and the like.

In embodiments, a benzoxazine resin include bisphenol A benzoxazine, bisphenol F benzoxazine, phenolphthalein benzoxazine, and the like and mixtures thereof.

In embodiments, a polyphenylene ether includes polyphenylene oxide (PPO), polyphenylene ether oligomers or polymers. The polyphenylene ether can be functionalized with hydroxyl, vinyl, isocyanate, anhydride, carboxylic acid, carboxylic ester, urethane, amino, phosphino, epoxy, silane, acrylate, methacrylate, and mixtures thereof. In embodiments, the polyphenylene ether has 1.2 to 2.8 phenolic hydroxy groups per molecule and polydispersity index of 1.2-3, intrinsic viscosity of 0.03-0.2 deciliter per gram.

In embodiments, a polyurethane is obtained by reacting isocyanates and polyols, in the presence of a thermal or photo initiator. Examples of isocyanates can include isocyanates described above under cyanate ester resin. Examples of the polyol include an alkylene oxide adduct of bisphenol A, an alkylene oxide adduct of aromatic diol, polyester polyol, acryl polyol, polyether polyol, polycarbonate polyol, polyalkylene polyol, and the like. Other types of hydroxyl group containing compounds which can be used as polyols in the preparation of the polyurethane include 2-hydroxy ethyl (meth)acrylate, 3-hydroxy propyl (meth)acrylate, 4-hydroxy-n-butyl (meth)acrylate, 2-hydroxy propyl (meth)acrylate, 2-hydroxy-n-butyl (meth)acrylate, 3-hydroxy-n-butyl (meth)acrylate, and mixtures thereof. A molar ratio of an isocyanate group (NCO) of the isocyanate compound to a hydroxyl group (OH) of the polyol is from 0.7 to 1.5, or 0.8 to 1.3, or 0.8 to 1.0.

In embodiments, examples of rubbery polymers include natural rubber (NR), butyl rubber, halogenated butyl rubber, and EPDM (ethylene propylene diene monomer rubber), styrene-butadiene rubber (SBR), butadiene rubber, synthetic polyisoprene rubber, epoxylated natural rubber, polybutadiene rubber, high-cis polybutadiene rubber, ethylene propylene diene monomer rubber, ethylene propylene rubber, maleic acid-modified ethylene propylene rubber, isobutylene-aromatic vinyl or diene monomer copolymers, brominated-NR, chlorinated-NR, brominated isobutylene p-methylstyrene copolymer, chloroprene rubber, epichlorohydrin homopolymers rubber, epichlorohydrin-ethylene oxide or allyl glycidyl ether copolymer rubbers, epichlorohydrin-ethylene oxide-allyl glycidyl ether terpolymer rubbers, chlorosulfonated polyethylene, chlorinated polyethylene, maleic acid-modified chlorinated polyethylene, methylvinyl silicone rubber, dimethyl silicone rubber, methylphenylvinyl silicone rubber, polysulfide rubber, vinylidene fluoride rubbers, tetrafluoroethylene-propylene rubbers, fluorinated silicone rubbers, fluorinated phosphagen rubbers, styrene elastomers, thermoplastic olefin elastomers, polyester elastomers, urethane elastomers, polyamide elastomers, and mixtures thereof.

In embodiments, amounts of other polymers and/or rubbery polymers are incorporated into the thermosetting composition, based on targeted end use application. In embodiments, the polymer and/or the rubber is added in amounts of 0-70, or 10-70, or 5-65, or 10-50, or 5-40, or 1-20, or 5-15, or 30-70, or 40-65, or up to 65 wt. %, based on total weight of the thermosetting composition.

(Optional Anti-scorching Agent)

The thermosetting composition containing the DIAEA-DVA copolymer can be cross-linked without the need of initiators, e.g., peroxide, etc., or with very little if needed. In some embodiments depending on the ratio of DIAEA to DVA and the storage condition, anti-scorching agents may be added. Anti-scorching agents prevent premature cross-linking of the vinyl groups in the copolymer before the targeted curing step. Anti-scorching agents allow the curing to happen at desired higher temperature. The effectiveness of the anti-scorching agent can be identified by the duration of scorch delay, the temperature at which the cross-linking begins, and the effect it has on the cure extent of the copolymer.

In embodiments, the anti-scorching agent is selected from the group comprising of styrene, alpha-methyl styrene monomer (AMSM), alpha-methyl styrene dimer (AMSD), alpha-methyl styrene oligomer (AMSO), hindered phenolic compounds which are substituted by an alkyl group, a phenyl group, or the like at the ortho position to at least one phenolic OH group, non-hindered phenolic compounds, amine compounds, thiourea compounds, benzimidazoles, mixtures and derivatives thereof. The alpha-methyl styrene derivatives can have one or more functional groups located on each ring and can be all same or different.

In embodiments, the alpha-methyl styrene dimer is selected from the group consisting of 2,4-diphenyl-4-methyl-1-pentene, 2,4-diphenyl-4-methyl-2-pentene, 1,2-trimethyl-3-phenylindane, cis-1,3-dimethyl-1,3-diphenyl cyclobutene, trans-1,3-dimethyl-1,3-diphenyl cyclobutene, and mixtures thereof.

In embodiments, the thermosetting composition contains a single anti-scorching agent or a mixture of two or more anti-scorching agents. The mixture of anti-scorching agents can have at least one anti-scorching agent based on the alpha-methyl styrene dimer, and/or based on hydrocarbons without any heteroatom or polar groups.

In embodiments, the anti-scorching agent is added to the DIAEA-DVA copolymer in solution, or to thermosetting composition, in amounts of 0.001-10, or 0.005-10, or 0.010-10, or 0.050-10, or 0.001-5, or 0.005-5, or 0.010-5, or 0.050-5, or up to 5 wt. %, based on total weight of the DIAEA-DVA copolymer.

(Optional Cross-Linking Agents):

As indicated that the thermosetting composition containing the DIAEA-DVA copolymer can be cross-linked without the need of initiators, in embodiments and depending on the formulations, at least a curing or cross-linking agent is added.

In embodiments, the cross-linking agent has one or more functional groups, e.g., vinyl, allyl, acryloyl, methacryloyl, maleimide, isocyanurate, etc. Examples of the cross-linking agents include triallyl isocyanurate (TAIL), triglycidyl isocyanurate, glycidyl methacrylate, 4-(glycidyloxy)-styrene, vinyl benzyl alcohol, 2-(4-ethenylphenoxymethyl)oxirane, vinyl functionalized phosphonate oligomers, 9,10-dihydro-9-oxa-10-phosphaphenanthrene-10-oxide (DOPO), tetramethylene diisocyanate, hexamethylene diisocyanate, methylene diisocyanate, trimethylhexamethylene diisocyanate, 4,4-diphenylmethane diisocyanate, 2,4-tolylene diisocyanate, 2,6-tolylene diisocyanate, naphthalene-1,5-diisocyanate, o-xylylene diisocyanate, m-xylylene diisocyanate, 24-tolylene dimer, bicycloheptane triisocyanate, 4,4-methylene bis(cyclohexylisocyanate), isophorone diisocyanate, tetramethylguanidine, 2-methylimidazole, 1-benzyl-2-methylimidazole, 2-ethyl-4-methylimidazole, adipic acid hydrazide, naphthalenecarboxylic acid hydrazide, N,N-dimethylaniline, N,N-dimethylbenzylamine, 2,4,6-tris(dimethylaminomethyl)phenol, 4,4′-diaminodiphenylmethane, 4,4′-diaminodiphenylsulfone, 3,3′-diaminodiphenylsulfone, m-phenylenediamine, m-xylylenediamine, diethyl toluenediamine, diethylenetriamine, triethylenetetramine, isophoronediamine, bis(aminomethyl)norbornane, bis(4-aminocyclohexyl)methane, dimer acid ester of polyethyleneimine, maleic anhydride (MA), phthalic anhydride (PA), hexahydro-o-phthalic anhydride (HEPA), tetrahydrophthalic anhydride (THPA), pyromellitic dianhydride (PMDA), trimellitic anhydride (TMA), diallyl bisphenol compound, diallyl phthalate (DAP), cycloaliphatic carboxylic acid anhydrides (such as cyclohexane-1,2-dicarboxylic anhydride), α,α′-bis(t-butylperoxy-m-isopropyl)benzene, and mixtures thereof.

Examples of other cross-linking agents include copper (II) or aluminum (III) salt of an aliphatic or aromatic carboxylic acid. Suitable examples of such salts contain the copper (II) and aluminum (III) salts of acetate, stearate, gluconate, citrate, benzoate, and like.

In embodiments, the cross-linking agent used in amounts of up to 15, or 0.1-10, or 0.5-5, or 1-10, or 0.1-5, or 0.5-5, or <2, or <1, or <0.5 wt. %, based on total weight of the thermosetting composition.

(Thermosetting Compositions)

In embodiments for use in prepregs, a thermosetting composition is prepared comprising up to 100 wt. % of a DIAEA-DVA copolymer, or preferably (i) 25-99.90 wt. % of DIAEA-DVA copolymer, (ii) 0.1-30 wt. % of at least an additive, and (iii) up to 65 wt. % of a polymer different from the DIAEA-DVA copolymer, based on total weight of the thermosetting composition.

In embodiments for a film for flexible metal-clad laminates, the thermosetting composition comprises: (i) 30-85 wt. % of a DIAEA-DVA copolymer, (ii) 2-10 wt. % of a second polymer, (iii) 12.9-50 wt. % of a filler, and (iv) 0.1-10 wt. % of at least an additive, based on total weight of the DIAEA-DVA copolymer and the second polymer.

(Methods to Prepare Thermosetting Compositions)

The DIAEA-DVA copolymer is provided in a dry form, e.g., pellets, powder, flakes, or solution form (in solvent), then mixed with other components in solvent, forming the thermosetting composition for use in electronics applications, e.g., prepreg in copper clad laminate (CCL), printed circuit boards (PCB), a film in flexible clad laminates, build-up films, etc. The solution form of DIAEA-DVA copolymer can be obtained by mixing the copolymer into a solvent (with or without the addition of anti-scorching agent).

In embodiments, the thermosetting composition is prepared by mixing suitable amounts of components in a solvent or a mixture of solvents to obtain a dispersion or solution. The solvent is selected from the group consisting of protic, aprotic, polar, nonpolar, and mixtures thereof. Examples of solvents include toluene, cyclopentane, cyclohexane, cycloheptane, cyclooctane, hexane, heptane, nonane, decane, paraffinic oil, methyl-tert-butyl ether, tetrahydrofuran (THF), dioxan, ethyl acetate, dimethylsulfoxide (DMSO), dimethylformamide (DMF), methanol, ethanol, propanol, butanol, toluene, xylene, p-xylene, methyl ethyl ketone (MEK), limonene, α-pinene, β-pinene, and mixtures thereof. The concentration of the thermosetting composition in the solvent(s) can be in the range from 2-60%, or 5-50%, or 10-40%, or 30-60%, or 40-60%, or 20-50%, based on total weight of the solution/dispersion.

In embodiments, an anti-scorching agent is added to the solution in an amount of 0-15, or <15, or <12, or <10, or <5, or <2, or <1 wt. %, based on total weight of the thermosetting composition.

(Forming Cured Thermosetting Composition)

The thermosetting composition can be cured by using an external source, e.g., heat, ultraviolet light (UV), visible light, electron beam, or combinations thereof, to obtain a cured thermosetting composition. The curing of the thermosetting composition can be conducted with or without initiator/cross-linking agent. The composition can be cured after being formed into a film.

In embodiments, the thermosetting composition is made into a film for use various electronic applications. The film can be obtained by processes known in the art, e.g., solvent casting, electrospinning, coating, flow coating, roll coating, bar coating, spray coating, brushing, spin coating, slot-die coating, or ultrasonic spray coating, and other process known in the art for coating a polymer in solution.

In embodiments, the film of the thermosetting composition is prepared by solvent casting on a support substrate (e.g., glass, plastic, metal, etc.). The solvent in the film can be removed at room temperature or at a temperature of <50° C. to avoid any pre-mature curing/crosslinking to obtain an uncured film. Such film of the thermosetting composition can be cured/cross-linked at a temperature of 120-180° C., or 125-175° C., or 130-160° C., or 120-160° C., or 140-180° C., for a period of 0.5-60 min, or 1-50 min, or 5-40 min, or 10-30 min. The film after curing can be made as a free-standing film by removing the support substrate.

In embodiments, the film obtained by solvent casting with solvent removal at temperatures, e.g., 120-180° C., to evaporate the solvent and to cure/crosslink the film. The support substrate can be removed after curing of the film.

In embodiments, the film of the thermosetting composition is prepared by solvent casting on a support (e.g., glass, plastic, metal, etc.). The solvent in the film can be removed at room temperature or at a temperature of <50° C. followed by compressing the film (free-standing film, without support) under pressure and curing at a suitable temperature, e.g., 120-180° C.

In embodiments, the film after curing has a thickness of 10 μm-1 mm, or 15 μm 500 μm, or 20 μm-300 μm, or 10 μm-150 μm, or 10 μm-120 μm.

In embodiments after curing, >60%, or >65%, or >70%, or >75%, or >80%, or >85%, or >90%, or >99% of vinyl groups in the DIAEA-DVA copolymer are consumed for the crosslinking step (based on total vinyl groups present in the DIAEA-DVA copolymer before curing).

(Prepreg of Thermosetting Compositions)

The thermosetting composition can also be used forming prepregs for copper clad laminates. In embodiments, a prepreg composition is formed comprising: (A) 20-70 wt. % of a thermosetting composition, (B) 30-80 wt. % of a reinforcing material, and (C) up to 10 wt. % of at least an additive; preferably, (A) 25-65 wt. % of thermosetting composition, (B) 35-75 wt. % of reinforcing material, and (C) up to 10 wt. % of at least an additive; more preferably, (A) 30-60 wt. % of thermosetting composition, (B) 40-70 wt. % of reinforcing material, and (C) up to 10 wt. % of at least an additive.

In embodiments, the prepreg composition is heat treated at a temperature of 120-220° C., or 130-210° C., or 140-200° C., to obtain the prepreg.

In embodiments, the components of the thermosetting composition are blended in a continuous mixer and the blend is fed directly from the continuous mixer onto a prepreg line where it is deposited onto a moving reinforcing material, e.g., fibers and consolidated into the fibrous layer usually by passage through nip rollers. The obtained prepreg can then be rolled and stored or transported to the location at which it is to be used.

In embodiments, the prepreg includes the semi-cured thermosetting composition (B-staged) and the reinforcing material or includes an uncured thermosetting composition (A-stage) and the reinforcing material. The obtained prepreg by either method, can be further cured at a desired temperature or used as is for different applications, e.g., copper clad laminate (CCL).

The reinforcing material can be selected from the group consisting of woven, non-woven, particulate, fibers, and mixtures thereof. Fibers can be selected from isotropic fibers, anisotropic fibers, natural fibers, synthetic fibers, woven fibers, or non-woven fibers. Examples of fibers include PTFE fibers, polyphenylene sulfide (PPS) fibers, glass fibers, carbon fiber, natural fibers (such as basalt, hemp, seagrass, hay, flax, straw, coconut, wood, cellulose, cotton, jute, sisal, bamboo, etc.), aramie, aramid fibers, boron fibers, alumina fibers, silicon carbide fibers, ceramic fibers, and mixtures thereof.

Examples of glass fibers include E-glass fibers, D-glass fibers, S-glass fibers, R glass, M glass, C glass, ECR glass, T-glass fibers, L-glass fibers, NE glass fibers, AR glass fibers, hollow glass fiber, and mixtures thereof.

In embodiments, the reinforcing material is fiber in the form of random, knitted, multi-axial or any other suitable pattern. Fiber can have a circular or almost circular cross-section with a diameter in the range of 1-30 μm, or 2-25 μm, or 5-20 μm, or 1-15 μm, or 5-15 μm, or 1-10 μm. Fiber can be cut short with a length of 2.5-50 mm, or 5-45 mm, or 10-40 mm to improve the fluidity and processing of the prepreg composition. Fiber can have a weight per unit area of the reinforcing fiber (a weight per 1 m 2 of the fiber) in the range of 10-650, or 20-600, or 30-500, or 40-400, or 50-350 g/m².

Other type of reinforcing materials include quartz glass cloth, glass cloth, polytetrafluoroethylene (PTFE), quartz, glass material, liquid crystal polymers, and mixtures thereof.

In embodiments, the reinforcing material is in the form of a woven fabric made up of fibers, wherein fiber bundles are aligned in one direction, represented by plain weave, twill weave, sateen weave, or non-crimp fabric. The woven fabric can be in the form of a stitching sheet in which sheets laminated by changing angles are stitched not to be loosened.

The reinforcing material can be used as is or subject to a surface treatment with a surface treating agent, e.g., silanes.

In embodiments, the prepreg is formed by impregnating the reinforcing material with the thermosetting composition, wherein the composition is in the form of a varnish. The varnish can be obtained by mixing the components of the composition in the solvent(s), and heating can be performed, if necessary. Components which are used, if necessary, dissolved in the solvent and are added to and dispersed in the mixture until a predetermined dispersion state is achieved using a ball mill, a bead mill, a planetary mixer, a roll mill, and the like, whereby a varnish like composition is prepared. Alternatively, the reinforcing material can be impregnated in the varnish by dipping, coating, and the like. If necessary, the impregnation can be repeated a plurality of times. While repeating the impregnation step, amounts of the thermosetting composition and the reinforcing material need to be adjusted to a desired concentration. The solvent can be removed from the prepreg by any means, e.g., at room temperature, in vacuum, or gently heating prepregs to allow the solvent to completely evaporate. The solvent can be removed by heating the prepreg at a temperature of 40-100° C., or 45-95° C., or 50-90° C., or 55-85° C., or 50-80° C., or 40-65° C.

The solvent for prepreg can be selected from perfluorohexane, α,α,α-trifluorotoluene, pentane, hexane, cyclohexane, methylcyclohexane, decalin, dioxane, carbon tetrachloride, trichlorofluoromethane, benzene, toluene, triethyl amine, carbon disulfide, diisopropyl ether, diethyl ether, t-butyl methyl ether (MTBE), chloroform, ethyl acetate, 1,2-dimethoxyethane, 2-methoxyethyl ether, tetrahydrofuran (THF), methylene chloride, pyridine, methyl ethyl ketone (MEK), methyl n-amyl ketone (MAK), methyl n-propyl ketone (MPK), acetone, hexamethylphosphoramide, N-methylpyrrolidinone, nitromethane, dimethylformamide, acetonitrile, sulfolane, dimethyl sulfoxide, propylene carbonate, and mixtures thereof.

In embodiments, the prepreg is in the form of a standalone film or supported on a substrate, e.g., glass, plastic, ceramic, porcelain, and the like. Examples of plastic substrates include polycarbonate, acrylic, styrene, polyvinylchloride, polybisallyl carbonate, polyethylene terephthalate, bi-axially oriented polypropylene (BOPP), polyethylene naphthenate, triacetate, cellulose acetate, and the like.

In embodiments, the prepreg has a thickness of 10 μm-1 mm, or 15 μm-500 μm, or 20 μm-200 μm, or 10 μm-150 μm, or 10 μm-120 μm.

In embodiments, for the consolidation of uncured prepregs into a single composite, and cross-linking and curing, prepregs are cut to size, if necessary sewn together or otherwise fixed and compressed in a suitable mold under pressure with or without vacuum. The composite is cured at temperatures of >140° C., or >150° C., or >160° C., or 120-220° C., or 130-210° C., or 140-200° C. The composite obtained by compression at elevated temperatures, very good impregnation of the reinforcing material takes place owing to the fact that thermosetting compositions wet the reinforcing material very well before the crosslinking reaction, before a gelling occurs or the complete composition cures throughout due to the crosslinking reaction of the reactive or highly reactive thermosetting composition at elevated temperatures.

(Metal-Clad Laminate)

In embodiments, a metal-clad laminate is obtained by laminating a prepreg with a metal foil, e.g., copper foil, to obtain the metal-clad laminate. In embodiments, the metal-clad laminate is obtained by casting the prepreg film directly on the metal foil and then curing the film at a desired temperature to obtain the prepreg on the metal foil, which is then used for different end use applications.

In embodiments, the prepreg is present in between two metal foils in the metal-clad laminate. The metal-clad laminate can have at least one adhesive layer between prepreg and the metal foil. The adhesive layer can be selected from any known adhesive layers in prior art, employed in the manufacturing of metal-clad laminates.

In embodiments, the metal-clad laminate is obtained by one or more prepregs coated with a metal foil, e.g., copper foil, on both the upper and lower sides, vacuum laminated and cured for 80-140 min in a press at a curing pressure of 35-65 kg/cm 2, and a curing temperature of 180-220° C.

(Properties of DIAEA-DVA Copolymers)

In embodiments, the DIAEA-DVA copolymer is a resinous material having a good combination of molecular weight ranges and relatively broad molecular weight distributions (polydispersity index), which in part makes it more soluble in non-polar solvents, thereby enhancing their processibility.

In embodiments, the DIAEA-DVA copolymer has a solubility in a hydrocarbon solvent at 25° C. for a period of less than 4 hours of at least 10, or >20, or >30, or >50, or >70, or <99, or 10-75, or 20-65, or 10-60 wt. %, based on total weight of the solvent. Examples of solvents include hexane, heptane, octane, isooctane, cyclohexane, varnish maker and painter's naphtha (VM&P naphtha), petroleum ether, toluene, xylene, and mixtures thereof.

In embodiments, the DIAEA-DVA copolymer as a solid when dissolved in a hydrocarbon solvent forms a substantially gel-free solution, wherein <2, or <5, or <10, or <15 wt. % of the solid remains insoluble in the solvent.

In embodiments, the DIAEA-DVA copolymer solution, in a hydrocarbon solvent, has a Gel Content of 0.05-5, or 0.1-4.5, or 1-4, or <5, or <2, or <1 wt. %, based on total weight of the copolymer.

In embodiments, the DIAEA-DVA copolymer has a decomposition onset temperature of 200-450° C., or 220-420° C., or 240-400° C., or <600° C., or <500° C. or >300° C.

In embodiments, the DIAEA-DVA copolymer has a glass transition temperature (T_{g}) of 50-300° C., or 60-250° C., or 70-220° C., or 80-200° C., or 100-250° C., or 120-220° C. or >150° C., or <250° C., or <200° C., measured using differential scanning calorimetry (DSC) according to ASTM D3418 or dynamic mechanical analyzer (DMA).

In embodiments, the DIAEA-DVA copolymer has a moisture absorption coefficient of <0.1, or <0.08, or <0.05, measured at 25° C. according to ASTM D570.

In embodiments, the DIAEA-DVA copolymer has a density of >0.9, or >1.0, or 1.0-2.0, or 1.0-1.50 g/cc.

(Properties of Cured Thermosetting Composition)

The cured thermosetting composition has excellent cross-linking characteristics, toughness, flexibility, good chemical and oxidative stability, and enhanced fire retardancy useful for electronic applications.

In embodiments, the thermosetting composition after curing has a Dk (permittivity) of <2.80, or <2.70, or <2.60, or <2.50, or <2.4, measured at 10 GHz, according to ASTM D2520.

In embodiments, the thermosetting composition after curing has a Df (loss tangent) of <0.002, or <0.0018, or <0.0015, or <0.0005, or <0.0006, or 0.002-0.0001, or 0.0015-0.0001, measured at 10 GHz, according to ASTM D2520.

In embodiments, the thermosetting composition during the curing process has an exothermic energy value of >80, or >100, or >120, or >140, or >160, or >180, or >200 J/g, or 60-220, or 80-210, or 100-200 J/g. The exothermic energy is an indication of the degree of cross-linking, which can be measured by analyzing the exothermic peak obtained by raising the temperature from room temperature to 300 or 400° C. at a rate of 10° C./min using a differential scanning calorimeter (DSC).

The thermosetting composition after curing has good adhesion to metals, e.g., aluminum, copper, etc. In embodiments, the thermosetting composition after curing has a 180° peel strength to metal of 0.3-1.0, or 0.4-0.9, or 0.45-0.8, or 0.3-0.9 N/m, measured according to IPC 650 2.4.19.

In embodiments, the thermosetting composition after curing has a Swelling Content at room temperature of <30%, or <25%, or <20%, or <15%, or <10%, or <5%, or 0-30%, or 0-20%, or 0-10%, based on total initial weight of the cured thermosetting composition.

In embodiments, the thermosetting composition after curing has a Swelling Content at 90° C. of <30%, or <25%, or <20%, or <15%, or <10%, or <7%, or 0-30%, or 0-20%, or 0-10%, based on total initial weight of the cured polymer composition.

In embodiments, the thermosetting composition after curing has a Gel Content at room temperature after 4 hours, of >85%, or >88%, or >90%, or >95%, or >98%, or >99%, or up to 100%, based on total weight of cured thermosetting composition.

In embodiments, the thermosetting composition after curing has a Gel Content at 90° C. after 9 hours, of >85%, or >88%, or >90%, or >95%, or >98%, or >99%, or up to 100%, based on total weight of cured thermosetting composition.

In embodiments, the thermosetting composition before curing has a thermal conductivity of >0.1, or >0.15, or >0.2, or >0.25 W/m·K. In embodiments, the thermosetting composition after curing has a thermal conductivity of >1, or >1.5, or >2, or >2.5 W/m·K. Thermal conductivity is measured according to ASTM E1530.

(Properties of Prepreg)

In embodiments, a prepreg containing 20-70 wt. % of a thermosetting composition and 30-80 wt. % of glass fibers has: a Dk (permittivity) of <3.5, or <3.2, or <3.0; and a Df (loss tangent) of <0.004, or <0.0035, or <0.003, or 0.003-0.004, both measured at 10 GHz, according to ASTM D2520.

(Properties of Metal-Clad Laminate)

In embodiments, a metal-clad laminate containing at least one prepreg and at least one copper foil has: a Dk (permittivity) of <3.0, or <2.90, or <2.80, or <2.70, or <2.55; and a Df (loss tangent) of <0.002, or <0.0018, or <0.0015, or 0.002-0.0001, or 0.0015-0.0001, both measured at 10 GHz, according to ASTM D2520.

In embodiments, the metal-clad laminate has a coefficient of thermal expansion (CTE) of <30, or <28, or <25, or <22 ppm/° C., as measured using DMA over a range of −50 to 300° C.

In embodiments, a prepreg in the metal-clad laminate, has a 180° peel strength to metal of >0.3, or >0.35, or 0.3-1.0, or 0.4-0.9, or 0.3-0.8 N/m, measured according to IPC 650 2.4.19.

(Applications of Thermosetting Composition)

The thermosetting composition can be used in coating applications for automotive, e.g., refinishes, primers, basecoats, undercoats, overcoats, clear coats, etc. Power cables can be obtained from the thermosetting composition, particularly, cables in high voltage applications, and useful in both, alternating current (AC) and direct current (DC) applications.

In embodiments, the thermosetting composition can be used in the preparation of prepregs, laminated boards, or printed circuit boards (PCBs).

In embodiments, the thermosetting composition is used in the manufacturing of copper clad laminates (CCL). Such laminates can be used to fabricate components such as flexible or rigid laminated circuit boards that can be incorporated into end-use devices, e.g., televisions, computers, laptop computers, tablet computers, printers, cell phones, video games, DVD players, stereos, electronic encapsulants, and other consumer electronics.

### EXAMPLES

The following examples are intended to be non-limiting.

### Example 1

Preparation of copolymer of 1,3-DIPEB and divinylbenzene containing 37.26 wt. % m-DVB, 36.91 wt. % p-DVB, 10.36 wt. % m-EVB, and 14.59 wt. % p-EVB, based on total weight of divinylbenzene. In a 3-liter 3-neck flask charged with 921 g of cyclohexane and heated up to 65° C., added 0.0125 g of triflic acid with continuous stirring. A mixture of 64.5 g of 1,3-DIPEB, 185.7 g of divinylbenzene, and 250 g of cyclohexane was added over 30 min. After addition of the mixture, the reaction content was quenched with 750 mL of water and 2 g of NaHCO₃ followed by heating the reaction content at 65° C. for another 15 minutes. The aqueous layer was removed from the bottom. The remaining organic layer was washed with water several times. The copolymer product was recovered by removing the solvent.

### Example-2

A film of thermosetting composition containing the copolymer of example 1 was made by solution casting on PET support. The film was dried at room temperature by transfer to PET release liner, then heated to a temperature between 120 to 180° C. to cure the film. Tests were conducted. The film sample was shown to have a Gel Content of >90%, Dk of <2.8, and Df of <0.002. For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “includes” and its grammatical variants are intended to be non-limiting, such that recitation of items in a list is not to the exclusion of other like items that can be substituted or added to the listed items.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

Unless otherwise specified, all technical and scientific terms used herein have the same meanings as commonly understood by one of skill in the art to which the disclosed disclosure belongs. the recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A thermosetting composition comprising: a copolymer of (a) a diisoalkenylarene and (b) a divinylarene comprising m-divinylbenzene, p-divinylbenzene, m-ethylvinylbenzene, p-ethylvinylbenzene, and mixtures thereof; in a mole ratio of (a) to (b) from 15:1 to 1:15; and
wherein the thermosetting composition after curing at a temperature of greater than 120° C. is characterized as having:
a Gel Content of >90%, measured according to Gel Content Test as described in the specification;
a dielectric constant (Dk) of <2.8, measured at 10 GHz, according to ASTM D2520; and
a dissipation Factor (Df) of <0.002, measured at 10 GHz, according to ASTM D2520.

2. The thermosetting composition of claim 1, wherein divinylarene has a combination of m-divinylbenzene and p-divinylbenzene in an amount of up to 99 wt. %, based on total weight of divinylarene.

3. The thermosetting composition of claim 1, wherein divinylarene comprises m-divinylbenzene in an amount of >50 wt. %, based on total weight of divinylarene.

4. The thermosetting composition of claim 1, wherein divinylarene comprises a combination of m-ethylvinylbenzene and p-ethylvinylbenzene in an amount of <35 wt. %, based on total weight of divinylarene.

5. The thermosetting composition of claim 1, wherein divinylarene has a weight ratio of m-divinylbenzene to p-divinylbenzene of 5:1 to 1:5.

6. The thermosetting composition of claim 1, wherein the copolymer comprises: (a) 30 to 95 wt. % of polymerized diisoalkenylarene; (b) 5 to 70 wt. % of polymerized divinylarene; and (c) 0 to 15 wt. % of other polymerizable monomer, based on total weight of the thermosetting composition.

7. The thermosetting composition of claim 6, wherein the other polymerizable monomer is selected from the group consisting of styrene, 2-vinylbiphenyl, 3-vinylbiphenyl, 4-vinylbiphenyl, 1-vinylnaphthalene, 2-vinylnaphthalene, α-alkylated styrene, alkoxylated styrene, and mixtures thereof.

8. The thermosetting composition of claim 1, wherein diisoalkenylarene is diisopropenylbenzene having >75 wt. % of m-diisopropenylbenzene, based on total weight of diisopropenylbenzene.

9. The thermosetting composition of claim 1, wherein diisoalkenylarene has at least one of:
a moisture content of <150 ppm;
a 4-tert-buylcatechol content of <120 ppm; and
a Hazen (APHA) color of <50 in a solvent having a concentration of 10%, measured according to ASTM D1209.

10. The thermosetting composition of claim 1, wherein divinylarene comprises at least one of:
4-tert-buylcatechol (p-TBC) content of <1200 ppm; and
a moisture content of <130 ppm; and a naphthalene content of <1000 ppm.

11. The thermosetting composition of claim 1, wherein the thermosetting composition is cured at a temperature of 120 to 220° C.

12. The thermosetting composition of claim 1, wherein the thermosetting composition after curing has:
a Gel Content of >95%;
a dielectric constant (Dk) of <2.6; and
a dissipation Factor (Df) of <0.0015.

13. The thermosetting composition of claim 1, wherein the thermosetting composition after curing has at least one of:
a Swelling Content at room temperature of <30%;
a Swelling Content at 90° C. of <30%;
a thermal conductivity of >1 W/m·K, measured according to ASTM E1530; and
a 180° peel strength to metal of 0.3 to 1.0 N/m, measured according to IPC 650 2.4.19.

14. The thermosetting composition of claim 1, wherein the thermosetting composition comprises: (i) 25 to 99.90 wt. % of the copolymer; (ii) 0.1 to 30 wt. % of at least an additive; and (iii) up to 65 wt. % of a polymer different from the copolymer of claim 1, based on total weight of the thermosetting composition.

15. The thermosetting composition of claim 14, wherein the at least an additive is selected from the group consisting of initiators, activators, stabilizers, thickeners, coalescing agents, slip agents, release agents, antioxidants, antiozonants, color change pH indicators, plasticizers, tackifiers, film forming additives, UV stabilizers, fillers, flame retardants, viscosity modifiers, wetting agents, toughening agents, adhesion promoters, heat stabilizers, flow modifiers, antistatic agents, processing aids, stress-relief additives, water resistant agents, thermal conductivity-imparting agents, radical scavengers, anti-scorching agent, and mixtures thereof.

16. The thermosetting composition of claim 14, wherein the polymer is selected from the group consisting of polyphenylene ether, curable cyclic olefins or their copolymers, polydicyclopentadiene, polyesters, styrenic block copolymers (SBCs), polyolefins, polytetrafluoroethylene (PTFE), polyetherimide (PEI), maleimide resin, cyanate ester resin, epoxy resin, phenolic resin, benzoxazine resin, polyamide resin, polyimide resin, polyphenylene sulfide, polysulfone, polyesterimides, polyether sulfone, polyether ketone, polyurethane, polyether ethersulfones, poly(3-hydroxybutyrate), poly(4-hydroxybutyrate), poly(3-hydroxybutyrate-co-3-hydroxyvalerate), poly(ε-caprolactone), and mixtures thereof.

17. A prepreg composition comprising:
20 to 70 wt. % of the thermosetting composition of claim 1;
30 to 80 wt. % of a reinforcing material; and
up to 10 wt. % of at least an additive, based on total weight of the prepreg composition.

18. The prepreg composition of claim 17, wherein the reinforcing material is selected from the group consisting of polytetrafluoroethylene fibers, polyphenylene sulfide fibers, glass fibers, carbon fiber, aramid fibers, boron fibers, alumina fibers, silicon carbide fibers, ceramic fibers, and mixtures thereof.

19. The prepreg composition of claim 17, wherein the prepreg composition is heat treated at a temperature of 120-220° C. to obtain a prepreg.

20. A metal-clad laminate comprising the prepreg of claim 19 and a metal foil; wherein the metal-clad laminate is characterized as having at least one of:
a Dk of <3.0 and a Df of <0.002, both measured at 10 GHz, according to ASTM D2520;
a coefficient of thermal expansion of <30 ppm/° C., as measured using DMA over a range of −50 to 300° C.; and
the prepreg has a 180° peel strength to metal of >0.3 N/m, measured according to IPC 650 2.4.19.
